(19) United States
(12) Patent Application Publication
(10) Pub. No.: US 2025/0124696 A1
(43) Pub. Date: Apr. 17, 2025

(54) AUTOMATED DRIVING SOTIF VIA SIGNAL REPRESENTATION

(71) Applicant: QUALCOMM Incorporated, San Diego, CA (US)

(72) Inventors: Makesh Pravin JOHN WILSON, San Diego, CA (US); Ahmed Kamel SADEK, San Diego, CA (US); Avdhut JOSHI, San Marcos, CA (US); James POPLAWSKI, Canton, MI (US); Vishnuu APPAYA DHANABALAN, Munich (DE)

(21) Appl. No.: 18/825,645

(22) Filed: Sep. 5, 2024

Related U.S. Application Data
(60) Provisional application No. 63/590,899, filed on Oct. 17, 2023.

(51) Int. Cl. G06V 10/80; B60W 50/14; G01S 13/86; G01S 13/931; G06T 7/60; G06V 20/56

(52) U.S. Cl. CPC G06V 10/80; B60W 50/14; G01S 13/867; G01S 13/931; G06T 7/60; G06V 20/56

(57) ABSTRACT

Techniques are provided for detecting objects proximate to a vehicle with multiple signal paths. An example method for generating object representations with multiple signal paths includes obtaining image information from at least one camera module disposed on a vehicle, obtaining target information from at least one radar module disposed on the vehicle, generating a first detection representation with a first signal path based on the image information and the target information, generating a second detection representation with a second signal path based on the image information and the target information, wherein the second signal path is different than the first signal path, and outputting the first detection representation and the second detection representation.

### CROSS-REFERENCE TO RELATED APPLICATIONS

This application claims the benefit of U.S. Provisional Application No. 63/590,899, filed Oct. 17, 2023, entitled “AUTOMATED DRIVING SOTIF VIA SIGNAL REPRESENTATION,” which is assigned to the assignee hereof, and the entire contents of which are hereby incorporated herein by reference for all purposes.

### BACKGROUND

Vehicles are becoming more intelligent as the industry moves towards deploying increasingly sophisticated self-driving technologies that are capable of operating a vehicle with little or no human input, and thus being semi-autonomous or autonomous. Autonomous and semi-autonomous vehicles may be able to detect information about their location and surroundings (e.g., using ultrasound, radar, lidar, an SPS (Satellite Positioning System), and/or an odometer, and/or one or more sensors such as accelerometers, cameras, etc.). Autonomous and semi-autonomous vehicles typically include a control system to interpret information regarding an environment in which the vehicle is disposed to identify hazards and determine a navigation path to follow. The designs of autonomous vehicles may utilize industry standards for guidance on verification and validation measures required to achieve the Safety Of The Intended Functionality (SOTIF). SOTIF is generally defined as the absence of unreasonable risk due to hazards resulting from functional insufficiencies of the intended functionality, or by reasonably foreseeable misuses by persons. Industry standards, such as the International Organization for Standardization (ISO) 21448 standard, may provide additional requirements for implementing SOTIF in autonomous and semi-autonomous vehicles.

### SUMMARY

An example method for generating object representations with multiple signal paths according to the disclosure includes obtaining image information from at least one camera module disposed on a vehicle, obtaining target information from at least one radar module disposed on the vehicle, generating a first detection representation with a first signal path based on the image information and the target information, generating a second detection representation with a second signal path based on the image information and the target information, wherein the second signal path is different than the first signal path, and outputting the first detection representation and the second detection representation.

An example apparatus according to the disclosure includes at least one memory, at least one camera module, at least one radar module, at least one processor communicatively coupled to the at least one memory, the at least one camera, and the at least one radar module, and configured to: obtain image information from the at least one camera module disposed on a vehicle, obtain target information from the at least one radar module disposed on the vehicle, generate a first detection representation with a first signal path based on the image information and the target information, generate a second detection representation with a second signal path based on the image information and the target information, wherein the second signal path is different than the first signal path, and output the first detection representation and the second detection representation.

Items and/or techniques described herein may provide one or more of the following capabilities, as well as other capabilities not mentioned. Multiple sensors, such as cameras, radar and lidar, may obtain target information for objects proximate to an autonomous or semi-autonomous vehicle. The sensor inputs may be evaluated via different signal paths. Machine learning models may be implemented along the different signal paths. Parametric and non-parametric representations of object data may be generated. The fusion of signals from different sensors may improve the sensitivity of object detection. The multiple signal paths may improve the robustness of object detection and corresponding environment models. SOTIF standards may be realized. Other capabilities may be provided and not every implementation according to the disclosure must provide any, let alone all, of the capabilities discussed.

### BRIEF DESCRIPTION OF THE DRAWINGS

FIG. 1 is a top view of an example ego vehicle.

FIG. 2 is a block diagram of components of an example device, of which the ego vehicle shown in FIG. 1 may be an example.

FIG. 3 is a block diagram of components of an example transmission/reception point.

FIG. 4 is a block diagram of components of a server.

FIG. 5 is a block diagram of an example device.

FIG. 6 is a diagram of an example geographic environment.

FIG. 7 is a diagram of the geographic environment shown in FIG. 6 divided into a grid.

FIG. 8 is an example of an occupancy map corresponding to the grid shown in FIG. 7.

FIG. 9 is a block diagram of an example system for implementing robust object detection via different signal representations.

FIG. 10 is a block diagram of a first example functional architecture for implementing object detection signal redundancy.

FIG. 11 is a block diagram of a second example functional architecture for implementing object detection signal redundancy.

FIG. 12A in an example deep learning architecture for object detection.

FIG. 12B in another example deep learning architecture for object detection.

FIG. 13 is a process flow diagram of an example method for generating object representations with multiple signal paths.

FIG. 14 is a process flow diagram of an example method for generating one or more object lists based on multiple signal paths.

### DETAILED DESCRIPTION

Techniques are discussed herein for detecting objects proximate to a vehicle with multiple signal paths. Constructing robust environmental models is an important aspect for automated driving systems. Industry standards may require some level of redundancy to achieve SOTIF requirements. In an example, sensor-based redundancies may be implemented to reduce the impact of sensor failures. Redundancy may also be realized via the implementation of different signal paths. The signals received from various sensors, such as cameras, radar modules and lidar modules, may be processed jointly and fused in separate signal paths. In an example, a first signal path may be configured to generate parametric representations of objects based on a fusion of camera and radar inputs, and a second signal path may be configured to generate non-parametric representations of objects based on the camera and radar inputs. Other sensor inputs may also be used to generate the parametric and non-parametric representations of the objects. For example, various combinations of image, radar, and lidar signals may be fused to generate the representations. Machine learning models may be implemented to generate the representations of the detected objects. Different signal paths may be configured to use different backbones in the machine learning models. In an example, a common backbone may be utilized and separate training for each head may be enforced for handling redundancy. Other techniques, however, may be used.

Particular aspects of the subject matter described in this disclosure may be implemented to realize one or more of the following potential advantages. Redundancy requirements for SOTIF standards may be realized. Object detection performance based on the fusion of multiple sensors may be maintained, and the effectiveness of perception modules on a vehicle may be increased as compared to single sensor object detection techniques. The fusion of object detection results from different types of sensors may enable the detection of smaller objects, or other objects outside of the training of image processing models. Robust environment models may be generated based on the improved object detection and the redundant signal paths. Other advantages may also be realized.

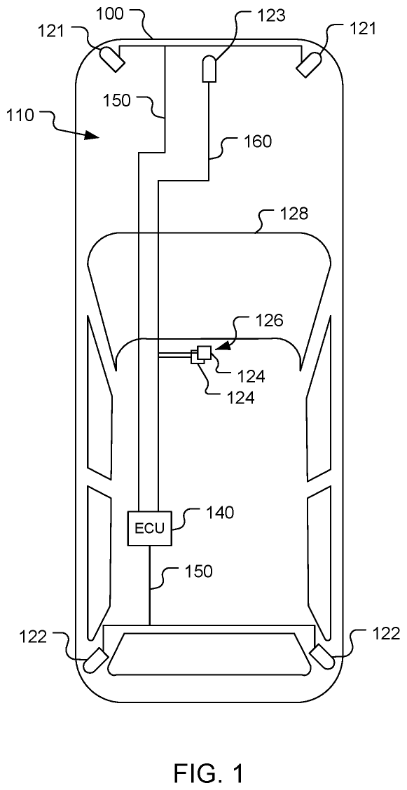

Referring to FIG. 1, an ego vehicle 100 includes an ego vehicle driver assistance system 110. The driver assistance system 110 may include a number of different types of sensors mounted at appropriate positions on the ego vehicle 100. For example, the system 110 may include: a pair of divergent and outwardly directed radar sensors 121 mounted at respective front corners of the vehicle 100, a similar pair of divergent and outwardly directed radar sensors 122 mounted at respective rear corners of the vehicle 100, a forwardly directed LRR sensor 123 (Long-Range Radar) mounted centrally at the front of the vehicle 100, and a pair of generally forwardly directed optical sensors 124 (cameras) forming part of an SVS 126 (Stereo Vision System) which may be mounted, for example, in the region of an upper edge of a windshield 128 of the vehicle 100. Each of the sensors 121, 122 may include an LRR and/or an SRR (Short-Range Radar). The various sensors 121-124 may be operatively connected to a central electronic control system which is typically provided in the form of an ECU 140 (Electronic Control Unit) mounted at a convenient location within the vehicle 100. In the particular arrangement illustrated, the front and rear sensors 121, 122 are connected to the ECU 140 via one or more conventional Controller Area Network (CAN) buses 150, and the LRR sensor 123 and the sensors of the SVS 126 are connected to the ECU 140 via a serial bus 160 (e.g., a faster FlexRay serial bus).

Collectively, and under the control of the ECU 140, the various sensors 121-124 may be used to provide a variety of different types of driver assistance functionalities. For example, the sensors 121-124 and the ECU 140 may provide blind spot monitoring, adaptive cruise control, collision prevention assistance, lane departure protection, and/or rear collision mitigation.

The CAN bus 150 may be treated by the ECU 140 as a sensor that provides ego vehicle parameters to the ECU 140. For example, a GPS module may also be connected to the ECU 140 as a sensor, providing geolocation parameters to the ECU 140.

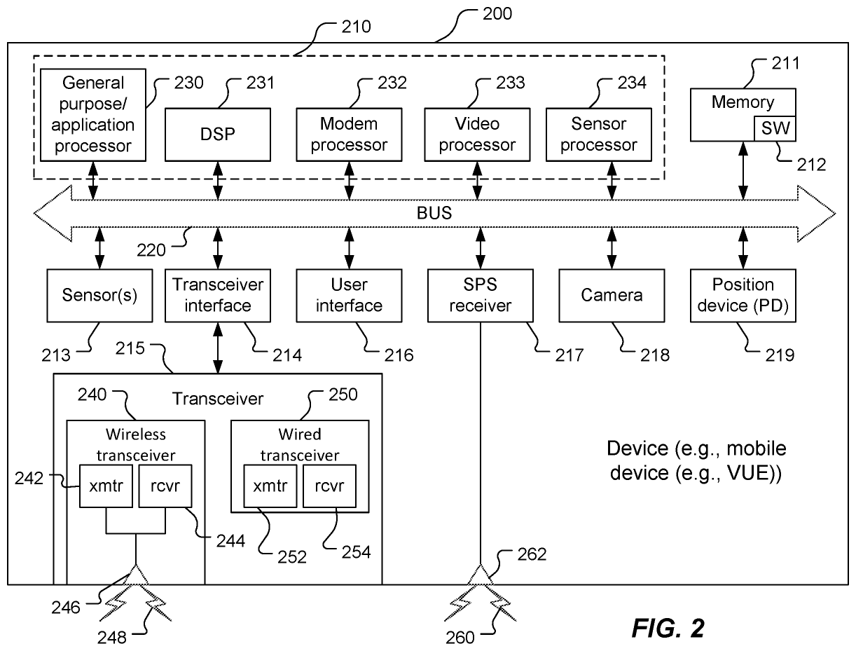

Referring also to FIG. 2, a device 200 (which may be a mobile device such as a user equipment (UE) such as a vehicle (VUE)) comprises a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The terms “user equipment” or “UE” (or variations thereof) are not specific to or otherwise limited to any particular Radio Access Technology (RAT), unless otherwise noted. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the device 200. The processor 210 may include one or more hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the device 200 for connectivity. The memory 211 may be a non-transitory, processor-readable storage medium that may include random access memory (RAM), flash memory, disc memory, and/or read-only memory (ROM), etc. The memory 211 may store the software 212 which may be processor-readable, processor-executable software code containing instructions that may be configured to, when executed, cause the processor 210 to perform various functions described herein. Alternatively, the software 212 may not be directly executable by the processor 210 but may be configured to cause the processor 210, e.g., when compiled and executed, to perform the functions. The description herein may refer to the processor 210 performing a function, but this includes other implementations such as where the processor 210 executes instructions of software and/or firmware. The description herein may refer to the processor 210 performing a function as shorthand for one or more of the processors 230-234 performing the function. The description herein may refer to the device 200 performing a function as shorthand for one or more appropriate components of the device 200 performing the function. The processor 210 may include a memory with stored instructions in addition to and/or instead of the memory 211. Functionality of the processor 210 is discussed more fully below.

The configuration of the device 200 shown in FIG. 2 is an example and not limiting of the disclosure, including the claims, and other configurations may be used. For example, an example configuration of the UE may include one or more of the processors 230-234 of the processor 210, the memory 211, and the wireless transceiver 240. Other example configurations may include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The device 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The device 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the device 200 in three dimensions) and/or one or more gyroscopes (e.g., three-dimensional gyroscope(s)). The sensor(s) 213 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the device 200 is fixed (stationary) or mobile and/or whether to report certain useful information, e.g., to an LMF (Location Management Function) regarding the mobility of the device 200. For example, based on the information obtained/measured by the sensor(s) 213, the device 200 may notify/report to the LMF that the device 200 has detected movements or that the device 200 has moved, and may report the relative displacement/distance (e.g., via dead reckoning, or sensor-based location determination, or sensor-assisted location determination enabled by the sensor(s) 213). In another example, for relative positioning information, the sensors/IMU may be used to determine the angle and/or orientation of another object (e.g., another device) with respect to the device 200, etc.

The IMU may be configured to provide measurements about a direction of motion and/or a speed of motion of the device 200, which may be used in relative location determination. For example, one or more accelerometers and/or one or more gyroscopes of the IMU may detect, respectively, a linear acceleration and a speed of rotation of the device 200. The linear acceleration and speed of rotation measurements of the device 200 may be integrated over time to determine an instantaneous direction of motion as well as a displacement of the device 200. The instantaneous direction of motion and the displacement may be integrated to track a location of the device 200. For example, a reference location of the device 200 may be determined, e.g., using the SPS receiver 217 (and/or by some other means) for a moment in time and measurements from the accelerometer(s) and gyroscope(s) taken after this moment in time may be used in dead reckoning to determine present location of the device 200 based on movement (direction and distance) of the device 200 relative to the reference location.

The magnetometer(s) may determine magnetic field strengths in different directions which may be used to determine orientation of the device 200. For example, the orientation may be used to provide a digital compass for the device 200. The magnetometer(s) may include a two-dimensional magnetometer configured to detect and provide indications of magnetic field strength in two orthogonal dimensions. The magnetometer(s) may include a three-dimensional magnetometer configured to detect and provide indications of magnetic field strength in three orthogonal dimensions. The magnetometer(s) may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to guided (e.g., wired electrical and/or optical) signals and from guided (e.g., wired electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi-D), Bluetooth® short-range wireless communication technology, Zigbee® short-range wireless communication technology, etc. New Radio may use mm-wave frequencies and/or sub-6 GHZ frequencies. The wired transceiver 250 may include a wired transmitter 252 and a wired receiver 254 configured for wired communication, e.g., a network interface that may be utilized to communicate with an NG-RAN (Next Generation-Radio Access Network) to send communications to, and receive communications from, the NG-RAN. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the device 200. For example, the user interface 216 may store indications of analog and/or digital signals in the memory 211 to be processed by DSP 231 and/or the general-purpose/application processor 230 in response to action from a user. Similarly, applications hosted on the device 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to guided signals, e.g., wired electrical or optical signals, and may be integrated with the antenna 246. The SPS receiver 217 may be configured to process, in whole or in part, the acquired SPS signals 260 for estimating a location of the device 200. For example, the SPS receiver 217 may be configured to determine location of the device 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the device 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the device 200.

The device 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the device 200, motion of the device 200, and/or relative position of the device 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the device 200 using terrestrial-based signals (e.g., at least some of the wireless signals 248) for trilateration, for assistance with obtaining and using the SPS signals 260, or both. The PD 219 may be configured to determine location of the device 200 based on a coverage area of a serving base station and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the device 200. The PD 219 may be configured to use one or more other techniques (e.g., relying on the UE's self-reported location (e.g., part of the UE's position beacon)) for determining the location of the device 200, and may use a combination of techniques (e.g., SPS and terrestrial positioning signals) to determine the location of the device 200. The PD 219 may include one or more of the sensors 213 (e.g., gyroscope(s), accelerometer(s), magnetometer(s), etc.) that may sense orientation and/or motion of the device 200 and provide indications thereof that the processor 210 (e.g., the general-purpose/application processor 230 and/or the DSP 231) may be configured to use to determine motion (e.g., a velocity vector and/or an acceleration vector) of the device 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the device 200, and may be provided by hardware, software, firmware, or various combinations thereof.

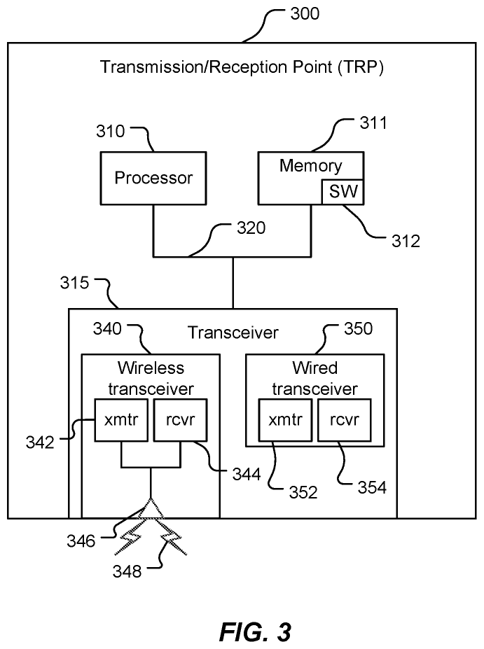

Referring also to FIG. 3, an example of a TRP 300 (e.g., of a base station such as a gNB (general NodeB) and/or an ng-eNB (next generation evolved NodeB) may comprise a computing platform including a processor 310, memory 311 including software (SW) 312, and a transceiver 315. Even if referred to in the singular, the processor 310 may include one or more processors, the transceiver 315 may include one or more transceivers (e.g., one or more transmitters and/or one or more receivers), and/or the memory 311 may include one or more memories. The processor 310, the memory 311, and the transceiver 315 may be communicatively coupled to each other by a bus 320 (which may be configured, e.g., for optical and/or electrical communication). One or more of the shown apparatus (e.g., a wireless transceiver) may be omitted from the TRP 300. The processor 310 may include one or more hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 may be a non-transitory storage medium that may include random access memory (RAM)), flash memory, disc memory, and/or read-only memory (ROM), etc. The memory 311 may store the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description herein may refer to the processor 310 performing a function, but this includes other implementations such as where the processor 310 executes software and/or firmware. The description herein may refer to the processor 310 performing a function as shorthand for one or more of the processors contained in the processor 310 performing the function. The description herein may refer to the TRP 300 performing a function as shorthand for one or more appropriate components (e.g., the processor 310 and the memory 311) of the TRP 300 performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to guided (e.g., wired electrical and/or optical) signals and from guided (e.g., wired electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the device 200, one or more other UEs, and/or one or more other devices) according to a variety of radio access technologies (RATs) such as 5G New Radio (NR), GSM (Global System for Mobiles), UMTS (Universal Mobile

Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi®-D), Bluetooth® short-range wireless communication technology, Zigbee® short-range wireless communication technology, etc. The wired transceiver 350 may include a wired transmitter 352 and a wired receiver 354 configured for wired communication, e.g., a network interface that may be utilized to communicate with an NG-RAN to send communications to, and receive communications from, an LMF, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 may be configured to perform or performs several functions, but one or more of these functions may be performed by an LMF and/or the device 200 (i.e., an LMF and/or the device 200 may be configured to perform one or more of these functions).

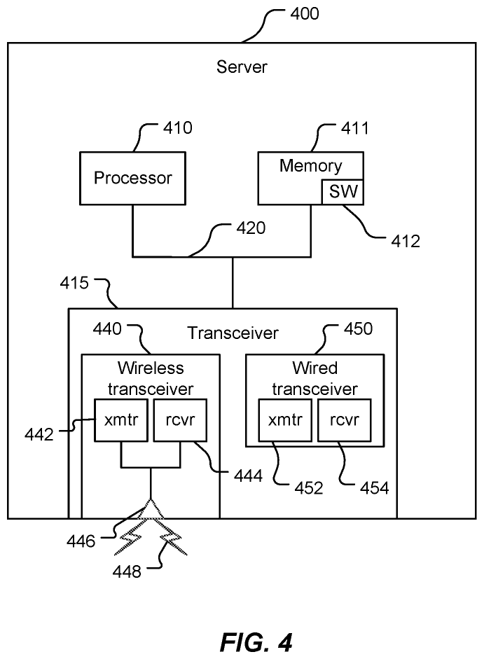

Referring also to FIG. 4, a server 400, of which an LMF is an example, may comprise a computing platform including a processor 410, memory 411 including software (SW) 412, and a transceiver 415. Even if referred to in the singular, the processor 410 may include one or more processors, the transceiver 415 may include one or more transceivers (e.g., one or more transmitters and/or one or more receivers), and/or the memory 411 may include one or more memories. The processor 410, the memory 411, and the transceiver 415 may be communicatively coupled to each other by a bus 420 (which may be configured, e.g., for optical and/or electrical communication). One or more of the shown apparatus (e.g., a wireless transceiver) may be omitted from the server 400. The processor 410 may include one or more hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 may be a non-transitory storage medium that may include random access memory (RAM)), flash memory, disc memory, and/or read-only memory (ROM), etc. The memory 411 may store the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description herein may refer to the processor 410 performing a function, but this includes other implementations such as where the processor 410 executes software and/or firmware. The description herein may refer to the processor 410 performing a function as shorthand for one or more of the processors contained in the processor 410 performing the function. The description herein may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to guided (e.g., wired electrical and/or optical) signals and from guided (e.g., wired electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the device 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi®-D), Bluetooth® short-range wireless communication technology, Zigbee® short-range wireless communication technology, etc. The wired transceiver 450 may include a wired transmitter 452 and a wired receiver 454 configured for wired communication, e.g., a network interface that may be utilized to communicate with an NG-RAN to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the device 200 (i.e., the TRP 300 and/or the device 200 may be configured to perform one or more of these functions).

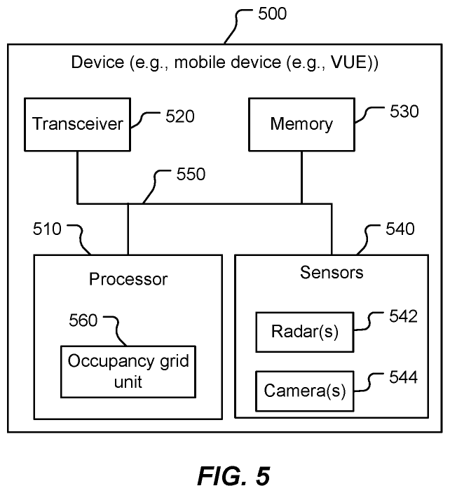

Referring to FIG. 5, a device 500 includes a processor 510, a transceiver 520, a memory 530, and sensors 540, communicatively coupled to each other by a bus 550. Even if referred to in the singular, the processor 510 may include one or more processors, the transceiver 520 may include one or more transceivers (e.g., one or more transmitters and/or one or more receivers), and the memory 530 may include one or more memories. The device 500 may take any of a variety of forms such as a mobile device such as a vehicle UE (VUE). The device 500 may include the components shown in FIG. 5, and may include one or more other components such as any of those shown in FIG. 2 such that the device 200 may be an example of the device 500. For example, the processor 510 may include one or more of the components of the processor 210. The transceiver 520 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the transceiver 520 may include the wired transmitter 252 and/or the wired receiver 254. The memory 530 may be configured similarly to the memory 211, e.g., including software with processor-readable instructions configured to cause the processor 510 to perform functions. The sensors 540 include one or more radar sensors 542 and one or more cameras 544. The sensors 540 may include one or more other sensors, such as lidar, Hall-effect sensors, ultrasound sensors, and/or one or more other sensors configured to assist vehicle operations.

The description herein may refer to the processor 510 performing a function, but this includes other implementations such as where the processor 510 executes software (stored in the memory 530) and/or firmware. The description herein may refer to the device 500 performing a function as shorthand for one or more appropriate components (e.g., the processor 510 and the memory 530) of the device 500 performing the function. The processor 510 (possibly in conjunction with the memory 530 and, as appropriate, the transceiver 520) may include an occupancy grid unit 560 (which may include an ADAS (Advanced Driver Assistance System) for a VUE). The occupancy grid unit 560 is discussed further herein, and the description herein may refer to the occupancy grid unit 560 performing one or more functions, and/or may refer to the processor 510 generally, or the device 500 generally, as performing any of the functions of the occupancy grid unit 560, with the device 500 being configured to perform the functions.

One or more functions performed by the device 500 (e.g., the occupancy grid unit 560) may be performed by another entity. For example, sensor measurements (e.g., radar measurements, camera measurements (e.g., pixels, images)) and/or processed sensor measurements (e.g., a camera image converted to a bird's-eye-view image) may be provided to another entity, e.g., the server 400, and the other entity may perform one or more functions discussed herein with respect to the occupancy grid unit 560 (e.g., using machine learning to determine a present occupancy grid and/or applying an observation model, analyzing measurements from different sensors, to determine a present occupancy grid, etc.).

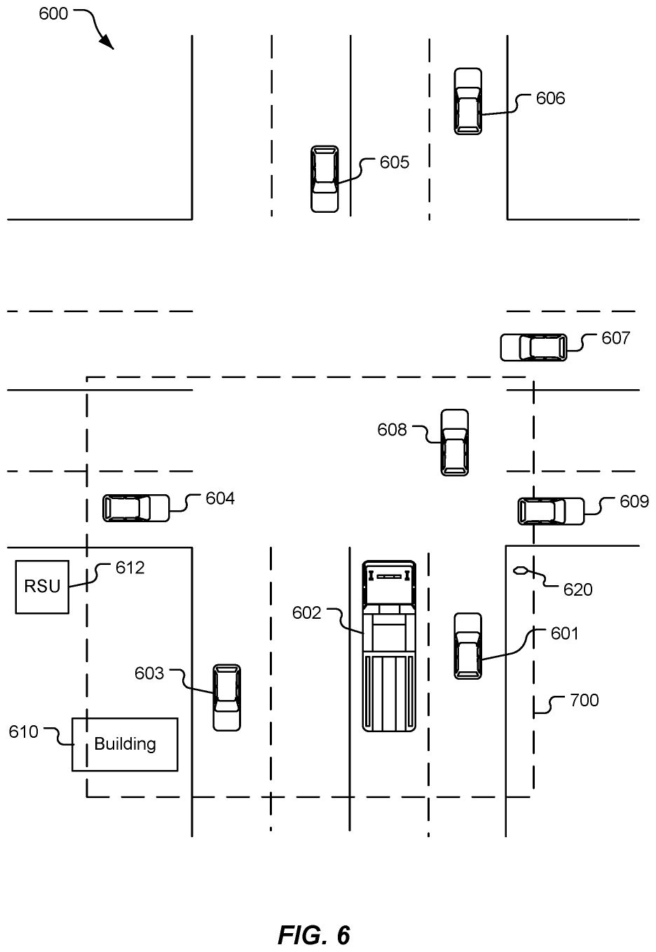

Referring also to FIG. 6, a geographic environment 600, in this example a driving environment, includes multiple mobile wireless communication devices, here vehicles 601, 602, 603, 604, 605, 606, 607, 608, 609, a building 610, an RSU 612 (Roadside Unit), and a street sign 620 (e.g., a stop sign). The RSU 612 may be configured similarly to the TRP 300, although perhaps having less functionality and/or shorter range than the TRP 300, e.g., a base-station-based TRP. One or more of the vehicles 601-609 may be configured to perform autonomous driving. A vehicle whose perspective is under consideration (e.g., for environment evaluation, autonomous driving, etc.) may be referred to as an observer vehicle or an ego vehicle. An ego vehicle, such as the vehicle 601 may evaluate a region around the ego vehicle for one or more desired purposes, e.g., to facilitate autonomous driving. The vehicle 601 may be an example of the device 500. The vehicle 601 may divide the region around the ego vehicle into multiple sub-regions and evaluate whether an object occupies each sub-region and if so, may determine one or more characteristics of the object (e.g., size, shape (e.g., dimensions (possibly including height)), velocity (speed and direction), object type or class (bicycle, car, truck, etc.), etc.).

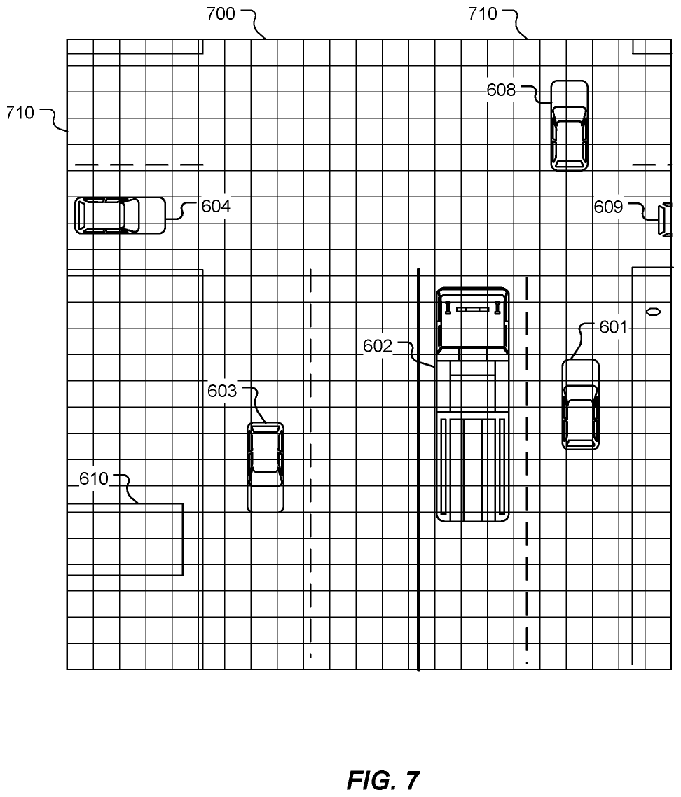

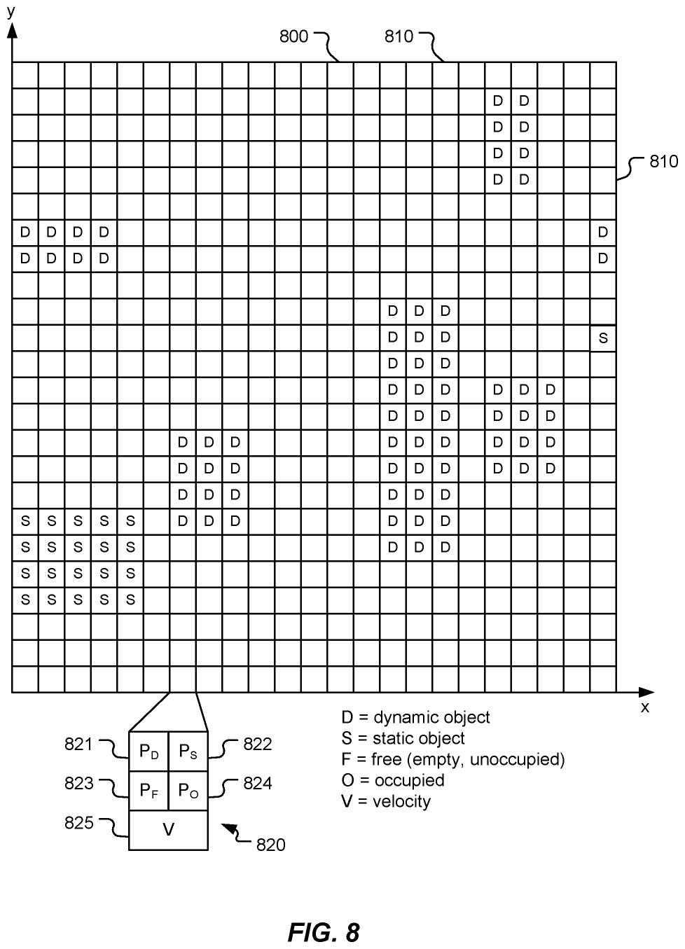

Referring also to FIGS. 7 and 8, a region 700, which in this example spans a portion of the environment 600, may be evaluated to determine an occupancy grid 800 (also called an occupancy map) that indicates multiple probabilities for each cell of the grid 800 whether the cell is occupied or free, and whether an occupying object is static or dynamic. For example, the region 700 may be divided into a grid, which may be called an occupancy grid, with sub-regions 710 that may be of similar (e.g., identical) size and shape, or may have two or more sizes and/or shapes (e.g., with sub-regions being smaller near an ego vehicle, e.g., the vehicle 601, and larger further away from the ego vehicle, and/or with sub-regions having different shape(s) near an ego vehicle than sub-region shape(s) further away from the ego vehicle). The region 700 and the grid 800 may be regularly-shaped (e.g., a rectangle, a triangle, a hexagon, an octagon, etc.) and/or may be divided into identically-shaped, regularly-shaped sub-regions for convenience sake, e.g., to simplify calculations, but other shapes of regions/grids (e.g., an irregular shape) and/or sub-regions (e.g., irregular shapes, multiple different regular shapes, or a combination of one or more irregular shapes and one or more regular shapes) may be used. For example, the sub-regions 710 may have rectangular (e.g., square) shapes. The region 700 may be of any of a variety of sizes and have any of a variety of granularities of sub-regions. For example, the region 700 may be a rectangle (e.g., a square) of about 100 m per side. As another example, while the region 700 is shown with the sub-regions 710 being squares of about 1 m per side, other sizes of sub-regions, including much smaller sub-regions, may be used. For example, square sub-regions of about 25 cm per side may be used. In this example, the region 700 is divided into M rows (here, 24 rows parallel to an x-axis indicated in FIG. 8) of N columns each (here, 23 columns parallel to a y-axis as indicated in FIG. 8). As another example, a grid may comprise a 512×512 array of sub-regions. Still other implementations of occupancy grids may be used.

Each of the sub-regions 710 may correspond to a respective cell 810 of the occupancy map and information may be obtained regarding what, if anything, occupies each of the sub-regions 710 and whether an occupying object is static or dynamic in order to populate cells 810 of the occupancy grid 800 with probabilities of the cell being occupied (O) or free (F) (i.e., unoccupied), and probabilities of an object at least partially occupying a cell being static (S) or dynamic (D). Each of the probabilities may be a floating point value. The information as to what, if anything, occupies each of the sub-regions 710 may be obtained from a variety of sources. For example, occupancy information may be obtained from sensor measurements from the sensors 540 of the device 500. As another example, occupancy information may be obtained by one or more other devices and communicated to the device 500. For example, one or more of the vehicles 602-609 may communicate, e.g., via C-V2X communications, occupancy information to the vehicle 601. As another example, the RSU 612 may gather occupancy information (e.g., from one or more sensors of the RSU 612 and/or from communication with one or more of the vehicles 602-609 and/or one or more other devices) and communicate the gathered information to the vehicle 601, e.g., directly and/or through one or more network entities, e.g., TRPs.

As shown in FIG. 8, each of the cells 810 may include a set 820 of occupancy information indicating a dynamic probability 821 (P_{D}), a static probability 822 (P_{S}), a free probability 823 (P_{F}), an occupied probability 824 (P_{P}), and a velocity 825 (V). The dynamic probability 821 indicates a probability that an object (if any) in the corresponding sub-region 710 is dynamic. The static probability 822 indicates a probability that an object (if any) in the corresponding sub-region 710 is static. The free probability 823 indicates a probability that there is no object in the corresponding sub-region 710. The occupied probability 824 indicates a probability that there is an object in (any portion of) the corresponding sub-region 710. Each of the cells 810 may include respective probabilities 821-824 of an object corresponding to the cell 810 being dynamic, static, absent, or present, with a sum of the probabilities being 1. In the example shown in FIG. 8, cells more likely to be free (empty) than occupied are not labeled in the occupancy grid 800 for sake of simplicity of the figure and readability of the occupancy grid 800. Also as shown in FIG. 8, cells more likely to be occupied than free, and occupied by an object that is more likely to be dynamic than static are labeled with a “D”, and cells more likely to be occupied than free, and occupied by an object that is more likely to be static than dynamic are labeled with a “S”. An ego vehicle may not be able to determine whether a cell is occupied or not (e.g., being behind a visible surface of an object and not discernable based on an observed object (e.g., if the size and shape of a detected object is unknown)), and such a cell may be labeled as unknown occupancy.

Building a dynamic occupancy grid (an occupancy grid with a dynamic occupier type) may be helpful, or even essential, for understanding an environment (e.g., the environment 600) of an apparatus to facilitate or even enable further processing. For example, a dynamic occupancy grid may be helpful for predicting occupancy, for motion planning, etc. A dynamic occupancy grid may, at any one time, comprise one or more cells of static occupier type and/or one or more cells of dynamic occupier type. A dynamic object may be represented as a set of one or more velocity vectors. For example, an occupancy grid cell may have some or all of the occupancy probability be dynamic, and within the dynamic occupancy probability, there may be multiple (e.g., four) velocity vectors each with a corresponding probability that together sum to the dynamic occupancy probability for that cell 810. A dynamic occupancy grid may be obtained, e.g., by the occupancy grid unit 560, by processing information from multiple sensors, e.g., of the sensors 540, such as from a radar system. Adding data from one or more cameras to determine the dynamic occupancy grid may provide significant improvements to the grid, e.g., accuracy of probabilities and/or velocities in grid cells.

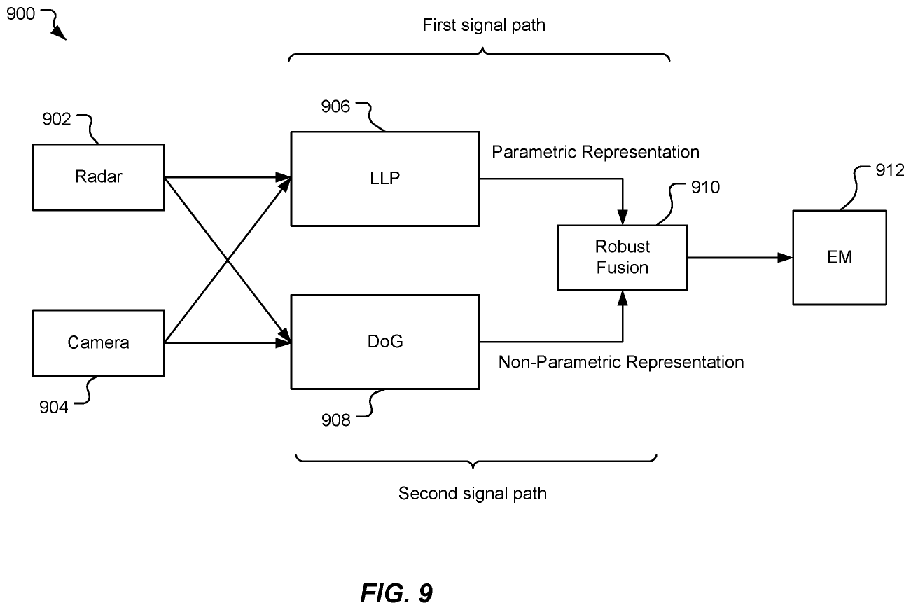

Referring to FIG. 9, a block diagram of an example system 900 for implementing robust object detection via different signal representations is shown. The system 900 includes a plurality of sensors such as a radar module 902, and a camera 904. In an example, the system 900 may be implemented in the device 500, the radar module 902 may be the one or more radar sensors 542, and the camera 904 may be the one or more cameras 544. The system 900 further includes functional blocks including an LLP functional block 906 (Low-Level Perception functional block), a dynamic occupancy grid (DoG) functional block 908, a robust fusion functional block 910, and an environment model 912. The LLP functional block 906 is a first signal path configured to receive input data from the radar module 902 and the camera 904 and generate parametric representations of objects in the received radar and image data. In an example, the parametric representation may be a structured list of elements associated with objects detected in the radar and camera data. The list of elements may include coordinate information for a detected object (e.g., grid coordinates x, y, z), object dimension information (e.g., length, width, height), object pose information, and object classification information. The DoG functional block 908 is a second signal path configured to receive input data from the radar module 902 and the camera 904 and generate non-parametric representations of objects in the received radar and image data. The non-parametric representations may be an occupancy map, such as described with respect to FIG. 8. For example, the non-parametric representations may be floating point numbers for each cell in a 512×512 grid indicating respective probabilities of the cell being occupied or free, and probabilities of an object occupying a cell being static or dynamic. Other information such as the motion of a dynamic cell (e.g., velocity in the x, y, and z directions) and classification information may be included in the non-parametric representations.

The robust fusion functional block 910 is configured to fuse the parametric and non-parametric representations into one or more object lists for the environment model 912. In an example, the fusion process in the robust fusion functional block 910 may utilize the object coordinate information in the parametric representations received from the LLP functional block 906 and the locations of the cells in the non-parametric representations received from the DoG functional block 908. The robust fusion functional block 910 may be configured to identify clusters within the non-parametric representations (e.g., clusters of dynamic grid cells) with similar properties, e.g., similar object classifications and/or similar velocities, and the indications of identified objects in the parametric representations (e.g., from the LLP functional block 906) to track objects, e.g., using a Kalman Filter (and/or one or more other algorithms). The robust fusion functional block 910 may be configured to output an object track list indicating tracked objects to the environment model 912. The object track list may include a location, velocity, length, and width (and possibly other information) for each object in the object track list. The object track list may include a shape to represent each object, e.g., a closed polygon or other shape (e.g., an oval (e.g., indicated by values for the major and minor axes)). The robust fusion functional block 910 may be configured to determine static objects (e.g., road boundaries, traffic signs, etc.) based on the parametric and/or non-parametric representations, and provide static object information to the environment model 912.

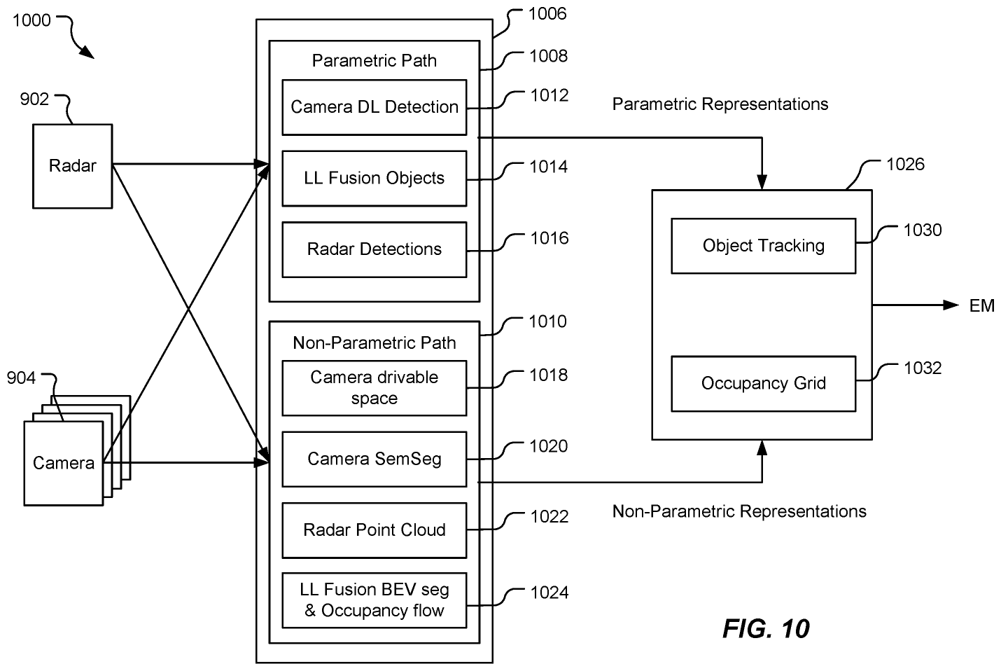

Referring to FIG. 10, a first example functional architecture 1000 for

implementing object detection signal redundancy is shown. The system 900 may be configured to utilize one or more features in the architecture 1000. In an example, the architecture 1000 may be implemented in one or more software modules 1006 configured to receive signals from the radar module 902 and the camera 904. The software module 1006 may include a first signal path 1008 configured to generate parametric representations, and a second signal path 1010 configured to generate non-parametric representations. The first and second signal paths 1008, 1010 may each include one or more modules including machine learning models configured to output the parametric and non-parametric representations respectively. The machine learning models may be based on deep learning techniques. For example, the first signal path 1008 may include a camera deep learning (DL) detection module 1012, a low-level (LL) fusion objects module 1014, and a radar detections module 1016. One or more of the modules 1012, 1014, 1016 may be trained to output parametric representations based on the inputs received from the radar module 902 and/or the camera 904. The second signal path 1010 may include a camera drivable space module 1018, a camera based semantic segmentation (Camer SemSeg) module 1020, a radar point cloud module 1022, and a low-level bird's eye view (BEV) segmentation and occupancy flow module 1024. One or more of the modules 1018, 1020, 1022, 1024 may be trained to output non-parametric representations based on the inputs received from the radar module 902 and/or the camera 904. The number of modules and types of machine learning models shown are examples, and not limitations, as other modules and machine learning techniques may also be used in the signal paths to generate the respective parametric and non-parametric representations.

The architecture 1000 may include a fusion functional block 1026 including an object tracking module 1030 and an occupancy grid module 1032. The object tracking module 1030 may be configured to use the parametric representations received via the first signal path 1008 with non-parametric representations received from the second signal path 1010 to track objects, e.g., using a Kalman Filter (and/or one or more other algorithms) and output an object track list indicating tracked objects to an environment model. The object track list may include a location, velocity, length, and width (and possibly other information) for each object in the object track list. The object track list may include a shape to represent each object, e.g., a closed polygon or other shape (e.g., an oval (e.g., indicated by values for the major and minor axes)). The occupancy grid module 1032 may be configured to determine static objects (e.g., road boundaries, traffic signs, etc.) in the parametric and/or non-parametric representations provided by the respective first signal path 1008 and the second signal path 1010. The static object information may be provided to an environment model.

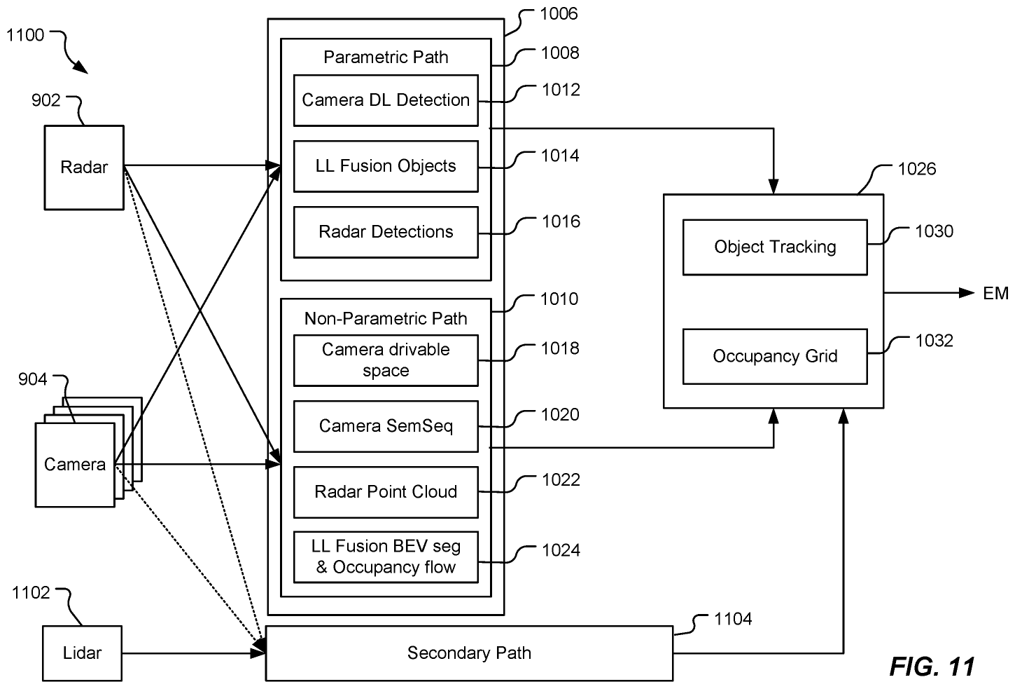

Referring to FIG. 11, with further reference to FIG. 10, a second example functional architecture 1100 for implementing object detection signal redundancy is shown. The second example architecture 1100 includes the features of the first example architecture 1000 and adds additional sensors and signal paths. In an example, a lidar module 1102 may be configured to provide signals (e.g., target information) to a secondary path 1104 that is separate from the first and second signal paths 1008, 1010. The secondary path 1104 may include one or more additional modules with machine learning models configured to provide object detection information to an environment model based on the target information received from the lidar module 1102. In an example, the secondary path 1104 may be configured to receive signals from the radar module 902 and/or the camera 904 to generate the object information for the environment model. The architecture 1100 further improves the robustness of the object detection functions by adding additional sensors and signal paths.

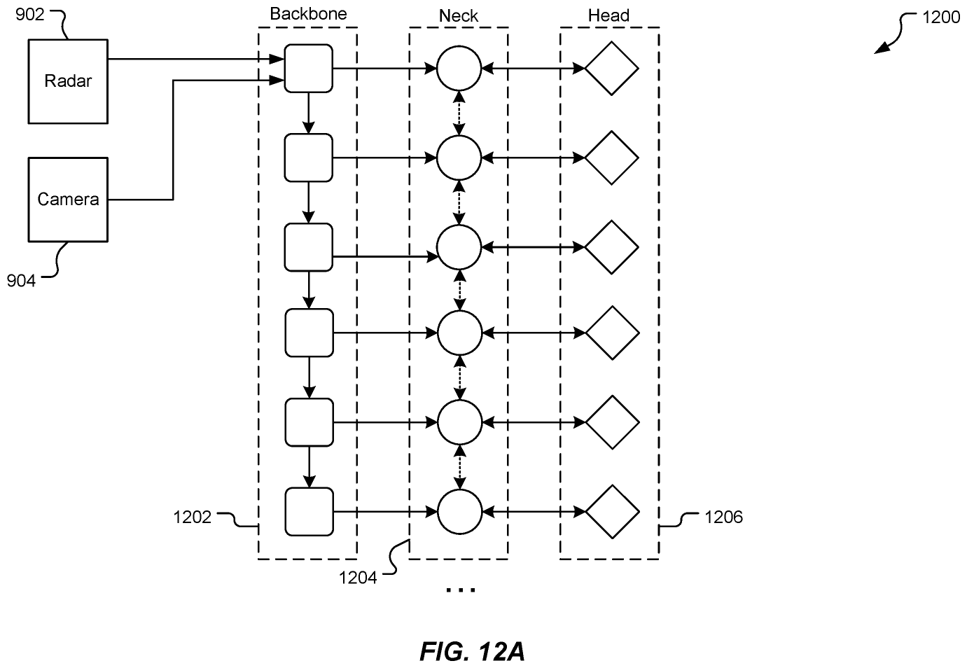

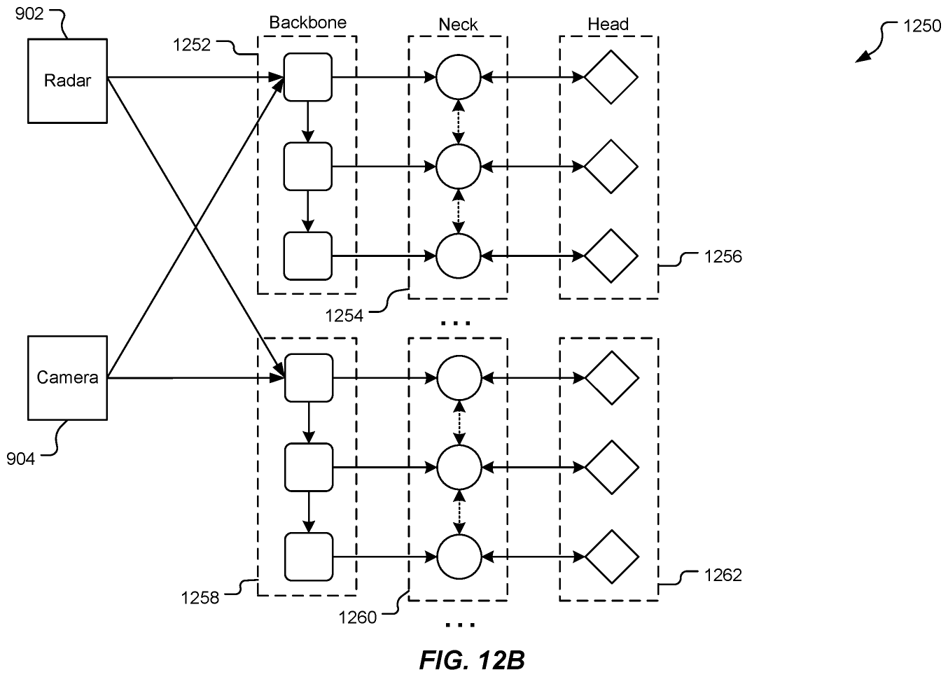

Referring to FIGS. 12A and 12B, example deep learning (DL) architectures for object detection are shown. In general, the DL architectures in FIGS. 12A and 12B include one or more backbone, neck and head models. The backbone models may be configured to extract and encode features from the input signals (e.g., from the radar module 902 and the camera 904). The neck models may be configured to transform and refine the features extracted by the backbone models. The head models may be configured for task-specific layers designed to produce a final prediction or inference based on the information extracted by the backbone and neck models. The head models may correspond to one or more of the modules 1012, 1014, 1016, 1018, 1020, 1022, 1024 in the respective first and/or second signal paths 1008, 1010.

In a first DL architecture 1200, a common backbone 1202 may be configured to receive signals from the radar module 902 and the camera 904. A first set of neck models 1204 and a first set of head models 1206 may be configured to generate the parametric and/or non-parametric representations associated with one or more of the modules 1012, 1014, 1016, 1018, 1020, 1022, 1024. In an example, separate training for each head model may be enforced for handling redundancy. In a second DL architecture 1250, the backbone, neck and head models may be separated based on the first and second signal paths. For example, a first backbone 1252 may be configured to receive signal inputs from the radar module 902 and the camera 904, and a second set of neck models 1254 and a second set of head models 1256 may be trained to generate the parametric representations. A second backbone 1258 may also be configured to receive signal inputs from the radar module 902 and the camera 904, and a third set of neck models 1260 and a third set of head models 1262 may be trained to generate the non-parametric representations. Other deep learning architectures may also be used to generate redundancy in the signal flows and improve the robustness of the object detection functions.

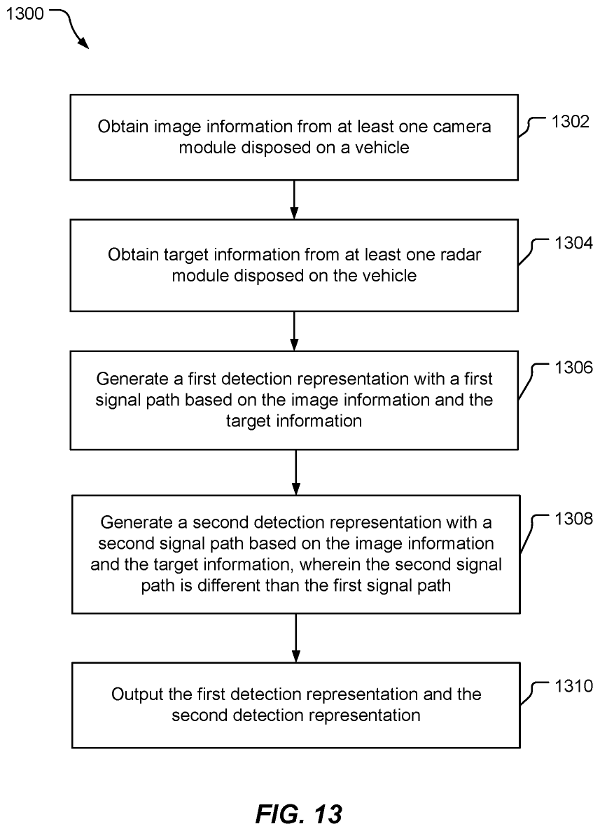

Referring to FIG. 13, with further reference to FIGS. 1-12B, a method 1300 for generating object representations with multiple signal paths includes the stages shown. The method 1300 is, however, an example and not limiting. The method 1300 may be altered, e.g., by having one or more stages added, removed, rearranged, combined, performed concurrently, and/or having one or more stages each split into multiple stages.

At stage 1302, the method 1300 includes obtaining image information with at least one camera module disposed on a vehicle. The device 500, including the processor 510 and the sensors 540, is a means for obtaining the image information. In an example, the cameras 544 may obtain images of the environment proximate to the vehicle. The images may include static objects, such as road signs, trees, barriers and other non-moving objects, and dynamic objects such as other vehicles, bicycles, pedestrians, and other moving objects. In an example, the image information may be obtained at a frame rate of approximately 40 ms. Other frame rates may be used.

At stage 1304, the method 1300 includes obtaining target information from at least one radar module disposed on the vehicle. The device 500, including the processor 510 and the sensors 540, is a means for obtaining the target information. In an example, the one or more radar sensors 542 may be configured to provide range, bearing and velocity information for objects generating a return radar signal (e.g., radar echo). In an example, the target information may be a scope plot based on echo signals. The radar target information may be obtained at a frame rate of approximately 40 ms. Other frame rates may be used.

At stage 1306, the method 1300 includes generating a first detection representation with a first signal path based on the image information and the target information. The device 500, including the processor 510, the sensors 540 and the architecture 1000, is a means for generating the first detection representation. In an example, the first detection representation includes one or more of the parametric representations generated via the first signal path 1008. The first signal path 1008 may include one or more machine learning models, such as described in the modules 1012, 1014, 1016 to generate the parametric representations. These modules and the corresponding parametric representations are examples, and not limitations, as the first signal path 1008 may utilize other modules to generate other detection representations. At stage 1308, the method 1300 includes generating a second detection

representation with a second signal path based on the image information and the target information, wherein the second signal path is different than the first signal path. The device 500, including the processor 510, the sensors 540 and the architecture 1000, is a means for generating the second detection representation. In an example, the second detection representation includes one or more of the non-parametric representations generated via the second signal path 1010. The second signal path 1010 may include one or more machine learning models, such as described in the modules 1018, 1020, 1022, 1024 to generate the non-parametric representations. These modules and the corresponding non-parametric representations are examples, and not limitations, as the second signal path 1010 may utilize other modules to generate other detection representations.

At stage 1310, the method 1300 includes outputting the first detection representation and the second detection representation. The device 500, including the processor 510, the sensors 540 and the architecture 1000, is a means for outputting the detection representations. In an example, the first detection representation and the second detection representation may be output to a fusion module configured to generate object lists based on the first and second representations. Other modules in an autonomous vehicle perception architecture may be configured to receive the first detection representation and the second detection representation (e.g., prior to fusing).

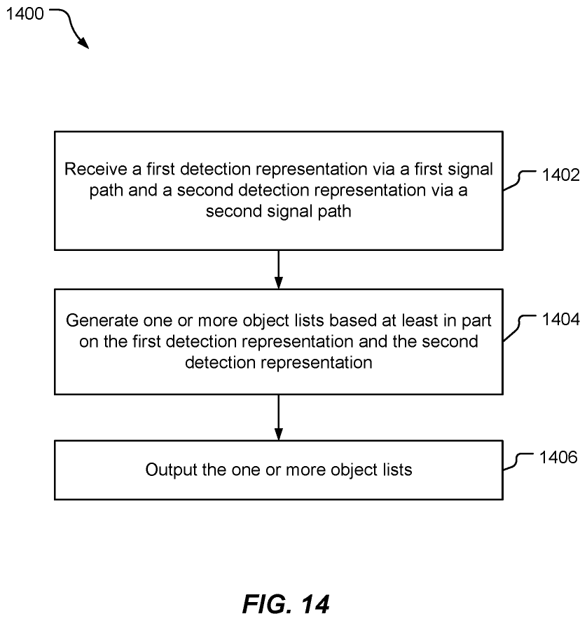

Referring to FIG. 14, with further reference to FIGS. 1-13, a method 1400 for generating one or more object lists based on multiple signal paths includes the stages shown. The method 1400 is, however, an example and not limiting. The method 1400 may be altered, e.g., by having one or more stages added, removed, rearranged, combined, performed concurrently, and/or having one or more stages each split into multiple stages.

At stage 1402, the method 1400 includes receiving a first detection representation via a first signal path and a second detection representation via a second signal path. The device 500, including the processor 510, the sensors 540 and the architecture 1000, is a means for receiving the first and second detection representation. In an example, the fusion functional block 1026 including an object tracking module 1030 and an occupancy grid module 1032 is configured to receive the parametric and non-parametric representations as the respective first and second detection representations.

At stage 1404, the method 1400 includes generating one or more object lists based at least in part on the first detection representation and the second detection representation. The device 500, including the processor 510, the sensors 540 and the architecture 1000, is a means for generating the one or more object lists. The object tracking module 1030 may be configured to use the parametric representations received via the first signal path 1008 with non-parametric representations received from the second signal path 1010 to track objects, e.g., using a Kalman Filter (and/or one or more other algorithms) and generate an object track list indicating tracked objects. The object track list may include a location, velocity, length, and width (and possibly other information) for each object in the object track list. The object track list may include a shape to represent each object, e.g., a closed polygon or other shape (e.g., an oval (e.g., indicated by values for the major and minor axes)). The occupancy grid module 1032 may be configured to determine static objects (e.g., road boundaries, traffic signs, etc.) in the parametric and/or non-parametric representations provided by the respective first signal path 1008 and second signal path 1010 and generate static object information.

At stage 1406, the method 1400 includes outputting the one or more object lists. The device 500, including the processor 510, the sensors 540 and the architecture 1000, is a means for outputting the one or more object lists. In an example, the fusion functional block 1026 may be configured to output the object track list and the static object information to an environment model. Other modules in an autonomous vehicle perception architecture may be configured to receive the one or more object lists (e.g., based on the fusion of the parametric and non-parametric representations of the sensor information).

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes at least one, i.e., one or more, of such devices (e.g., “a processor” includes at least one processor (e.g., one processor, two processors, etc.), “the processor” includes at least one processor, “a memory” includes at least one memory, “the memory” includes at least one memory, etc.). The phrases “at least one” and “one or more” are used interchangeably and such that “at least one” referred-to object and “one or more” referred-to objects include implementations that have one referred-to object and implementations that have multiple referred-to objects. For example, “at least one processor” and “one or more processors” each includes implementations that have one processor and implementations that have multiple processors. Also, a “set” as used herein includes one or more members, and a “subset” contains fewer than all members of the set to which the subset refers.

The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, a list of items prefaced by “at least one of” or prefaced by “one or more of” indicates a disjunctive list such that, for example, a list of “at least one of A, B, or C,” or a list of “at least one of A, B, and C,” or a list of “one or more of A, B, or C”, or a list of “one or more of A, B, and C,” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

Implementation examples are described in the following numbered clauses:

Clause 1. A method for generating object representations with multiple signal paths, comprising: obtaining image information from at least one camera module disposed on a vehicle; obtaining target information from at least one radar module disposed on the vehicle; generating a first detection representation with a first signal path based on the image information and the target information; generating a second detection representation with a second signal path based on the image information and the target information, wherein the second signal path is different than the first signal path; and outputting the first detection representation and the second detection representation.

Clause 2. The method of clause 1 wherein the first detection representation includes a parametric representation for a target object, and the second detection representation includes a non-parametric representation for the target object.

Clause 3. The method of clause 2 wherein the parametric representation for the target object includes coordinate information for the target object and dimension information for the target object.

Clause 4. The method of clause 2 wherein the non-parametric representation for the target object is an occupancy map.

Clause 5. The method of clause 2 wherein the first signal path includes at least a first machine learning model configured to generate the parametric representation based at least in part on the image information and the target information, and the second signal path includes at least a second machine learning model configured to generate the non-parametric representation based at least in part on the image information and the target information.

Clause 6. The method of clause 5 wherein the first machine learning model and the second machine learning model utilize a common backbone.

Clause 7. The method of clause 5 wherein the first machine learning model utilizes at least a first backbone, and the second machine learning model utilize a least a second backbone.

Clause 8. The method of clause 1 further comprising: receiving the first detection representation via the first signal path and the second detection representation via the second signal path; generating one or more object lists based at least in part on the first detection representation and the second detection representation; and outputting the one or more object lists.

Clause 9. The method of clause 8 wherein the one or more object lists includes an object track list indicating a location and velocity of an object.

Clause 10. The method of clause 9 wherein the object track list indicates a shape of the object.

Clause 11. The method of clause 9 wherein the one or more object lists includes static object information.

Clause 12. The method of clause 8 wherein outputting the one or more object lists includes providing the one or more object lists to an environment model.

Clause 13. The method of clause 8 further comprising: receiving target information from a lidar module disposed on the vehicle via a secondary path that is separate from the first signal path and the second signal path; generating object detection information based on the target information; and outputting the object detection information.

Clause 14. The method of clause 13 further comprising: receiving image information from the at least one camera module disposed on the vehicle; generating the object detection information based on the target information and the image information; and outputting the object detection information.

Clause 15. An apparatus, comprising: at least one memory; at least one camera module; at least one radar module; at least one processor communicatively coupled to the at least one memory, the at least one camera, and the at least one radar module, and configured to: obtain image information from the at least one camera module disposed on a vehicle; obtain target information from the at least one radar module disposed on the vehicle; generate a first detection representation with a first signal path based on the image information and the target information; generate a second detection representation with a second signal path based on the image information and the target information, wherein the second signal path is different than the first signal path; and output the first detection representation and the second detection representation.

Clause 16. The apparatus of clause 15 wherein the first detection representation includes a parametric representation for a target object, and the second detection representation includes a non-parametric representation for the target object.

Clause 17. The apparatus of clause 16 wherein the parametric representation for the target object includes coordinate information for the target object and dimension information for the target object.

Clause 18. The apparatus of clause 16 wherein the non-parametric representation for the target object is an occupancy map.

Clause 19. The apparatus of clause 16 wherein the first signal path includes at least a first machine learning model and the at least one processor is further configured to generate the parametric representation based at least in part on the image information and the target information, and the second signal path includes at least a second machine learning model and the at least one processor is further configured to generate the non-parametric representation based at least in part on the image information and the target information.

Clause 20. The apparatus of clause 19 wherein the first machine learning model and the second machine learning model utilize a common backbone.

Clause 21. The apparatus of clause 19 wherein the first machine learning model utilizes at least a first backbone, and the second machine learning model utilize a least a second backbone.

Clause 22. The apparatus of clause 15 wherein the at least one processor is further configured to: receive the first detection representation via the first signal path and the second detection representation via the second signal path; generate one or more object lists based at least in part on the first detection representation and the second detection representation; and output the one or more object lists.

Clause 23. The apparatus of clause 22 wherein the one or more object lists includes an object track list indicating a location and velocity of an object.

Clause 24. The apparatus of clause 23 wherein the object track list indicates a shape of the object.

Clause 25. The apparatus of clause 23 wherein the one or more object lists includes static object information.

Clause 26. The apparatus of clause 22 wherein the at least one processor is further configured to output the one or more object lists to an environment model.

Clause 27. The apparatus of clause 22 further comprising at least one lidar module disposed on the vehicle, wherein the at least one processor is further configured to: receive further target information from the at least one lidar module via a secondary path that is separate from the first signal path and the second signal path; generate object detection information based on the further target information; and output the object detection information.

Clause 28. The apparatus of clause 27 wherein the at least one processor is further configured to: generate the object detection information based on the target information and the image information; and output the object detection information.

Clause 29. An apparatus for generating object representations with multiple signal paths, comprising: means for obtaining image information from at least one camera module disposed on a vehicle; means for obtaining target information from at least one radar module disposed on the vehicle; means for generating a first detection representation with a first signal path based on the image information and the target information; means for generating a second detection representation with a second signal path based on the image information and the target information, wherein the second signal path is different than the first signal path; and means for outputting the first detection representation and the second detection representation.

Clause 30. The apparatus of clause 29 further comprising: means for receiving the first detection representation via the first signal path and the second detection representation via the second signal path; means for generating one or more object lists based at least in part on the first detection representation and the second detection representation; and means for outputting the one or more object lists.

Clause 31. The apparatus of clause 30 further comprising: means for receiving target information from a lidar module disposed on the vehicle via a secondary path that is separate from the first signal path and the second signal path; means for generating object detection information based on the target information; and means for outputting the object detection information.

Clause 32. A non-transitory processor-readable storage medium comprising processor-readable instructions configured to cause one or more processors to generate object representations with multiple signal paths, comprising code for: obtaining image information from at least one camera module disposed on a vehicle; obtaining target information from at least one radar module disposed on the vehicle; generating a first detection representation with a first signal path based on the image information and the target information; generating a second detection representation with a second signal path based on the image information and the target information, wherein the second signal path is different than the first signal path; and outputting the first detection representation and the second detection representation.

Clause 33. The non-transitory processor-readable storage medium of clause 32 further comprising: code for receiving the first detection representation via the first signal path and the second detection representation via the second signal path; code for generating one or more object lists based at least in part on the first detection representation and the second detection representation; and code for outputting the one or more object lists.

Clause 34. The non-transitory processor-readable storage medium of clause 33 further comprising: code for receiving target information from a lidar module disposed on the vehicle via a secondary path that is separate from the first signal path and the second signal path; code for generating object detection information based on the target information; and code for outputting the object detection information.

Clause 35. A method for generating object representations with multiple signal paths, comprising: receiving a first detection representation via a first signal path and a second detection representation via a second signal path; generating one or more object lists based at least in part on the first detection representation and the second detection representation; and outputting the one or more object lists.

Clause 36. An apparatus, comprising: at least one memory; at least one camera module; at least one radar module; at least one processor communicatively coupled to the at least one memory, the at least one camera, and the at least one radar module, and configured to: receive a first detection representation via a first signal path and a second detection representation via a second signal path; generate one or more object lists based at least in part on the first detection representation and the second detection representation; and output the one or more object lists.

Clause 37. An apparatus comprising: means for receiving a first detection representation via a first signal path and a second detection representation via a second signal path; means for generating one or more object lists based at least in part on the first detection representation and the second detection representation; and means for outputting the one or more object lists.

Clause 38. A non-transitory processor-readable storage medium comprising processor-readable instructions configured to cause one or more processors to generate object representations with multiple signal paths, comprising code for: receiving a first detection representation via a first signal path and a second detection representation via a second signal path; generating one or more object lists based at least in part on the first detection representation and the second detection representation; and outputting the one or more object lists.

1. An apparatus, comprising:
at least one memory;
at least one camera module;
at least one radar module;
at least one processor communicatively coupled to the at least one memory, the
at least one camera module, and the at least one radar module, and configured to:
obtain image information from the at least one camera module disposed on a vehicle;
obtain target information from the at least one radar module disposed on the vehicle;
generate a first detection representation with a first signal path based on the image information and the target information;
generate a second detection representation with a second signal path based on the image information and the target information, wherein the second signal path is different than the first signal path; and
output the first detection representation and the second detection representation.

2. The apparatus of claim 1 wherein the first detection representation includes a parametric representation for a target object, and the second detection representation includes a non-parametric representation for the target object.

3. The apparatus of claim 2 wherein the parametric representation for the target object includes coordinate information for the target object and dimension information for the target object.

4. The apparatus of claim 2 wherein the non-parametric representation for the target object is an occupancy map.

5. The apparatus of claim 2 wherein the first signal path includes at least a first machine learning model and the at least one processor is further configured to generate the parametric representation based at least in part on the image information and the target information, and the second signal path includes at least a second machine learning model and the at least one processor is further configured to generate the non-parametric representation based at least in part on the image information and the target information.

6. The apparatus of claim 5 wherein the first machine learning model and the second machine learning model utilize a common backbone.

7. The apparatus of claim 5 wherein the first machine learning model utilizes at least a first backbone, and the second machine learning model utilize a least a second backbone.

8. The apparatus of claim 1 wherein the at least one processor is further configured to:
receive the first detection representation via the first signal path and the second detection representation via the second signal path;
generate one or more object lists based at least in part on the first detection representation and the second detection representation; and
output the one or more object lists.

9. The apparatus of claim 8 wherein the one or more object lists includes an object track list indicating a location and velocity of an object.

10. The apparatus of claim 9 wherein the object track list indicates a shape of the object.

11. The apparatus of claim 9 wherein the one or more object lists includes static object information.

12. The apparatus of claim 8 wherein the at least one processor is further configured to output the one or more object lists to an environment model.

13. The apparatus of claim 8 further comprising at least one lidar module disposed on the vehicle, wherein the at least one processor is further configured to:
receive further target information from the at least one lidar module via a secondary path that is separate from the first signal path and the second signal path;
generate object detection information based on the further target information; and
output the object detection information.

14. The apparatus of claim 13 wherein the at least one processor is further configured to:
generate the object detection information based on the target information and the image information; and
output the object detection information.

15. A method for generating object representations with multiple signal paths, comprising:
obtaining image information from at least one camera module disposed on a vehicle;
obtaining target information from at least one radar module disposed on the vehicle;
generating a first detection representation with a first signal path based on the image information and the target information;
generating a second detection representation with a second signal path based on the image information and the target information, wherein the second signal path is different than the first signal path; and
outputting the first detection representation and the second detection representation.

16. The method of claim 15 wherein the first detection representation includes a parametric representation for a target object, and the second detection representation includes a non-parametric representation for the target object.

17. The method of claim 16 wherein the parametric representation for the target object includes coordinate information for the target object and dimension information for the target object.

18. The method of claim 16 wherein the non-parametric representation for the target object is an occupancy map.

19. The method of claim 16 wherein the first signal path includes at least a first machine learning model configured to generate the parametric representation based at least in part on the image information and the target information, and the second signal path includes at least a second machine learning model configured to generate the non-parametric representation based at least in part on the image information and the target information.

20. An apparatus for generating object representations with multiple signal paths, comprising:
means for obtaining image information from at least one camera module disposed on a vehicle;
means for obtaining target information from at least one radar module disposed on the vehicle;
means for generating a first detection representation with a first signal path based on the image information and the target information;
means for generating a second detection representation with a second signal path based on the image information and the target information, wherein the second signal path is different than the first signal path; and
means for outputting the first detection representation and the second detection representation.
